(19) United States
(12) Patent Application Publication
(10) Pub. No.: US 2010/0146767 A1
(43) Pub. Date: Jun. 17, 2010

(54) MANUFACTURING METHOD FOR IMAGE DISPLAY APPARATUS

(75) Inventors: Kazutaka Yanagita, Yokohama-shi (JP); Kazuhiro Nagasaka, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/634,602

(22) Filed: Dec. 9, 2009

(30) Foreign Application Priority Data
Dec. 16, 2008 (JP) 2008-319088(PAT.)

(51) Int. Cl. B23P 11/02

(52) U.S. Cl. 29/446

(57) ABSTRACT

Grasping of an elongated plate shaped spacer is performed such that a portion of each face of grasping members is brought into contact with the side of the elongated plate shaped spacer, wherein the region of contact between the grasping members and the side of the elongated plate shaped spacer is gradually spread toward the edge of the elongated plate shaped spacer in the longitudinal direction thereof. Thus, a method of manufacturing an image display apparatus can be provided wherein elongated plate shaped spacers can be positioned on a substrate with high positional precision.

### BACKGROUND OF THE INVENTION

1. Field of the Invention

The present invention relates to a manufacturing method for an image display apparatus having an elongated plate-shaped spacer.

2. Description of the Related Art

Conventionally, there has been known an image display apparatus having a face plate and a rear plate, with a fluorescent substance provided to the face plate and multiple electron-emitting devices provided to the real plate in matrix fashion. With this image display apparatus, a vacuum exists between the face plate and the rear plate, so spacers are arrayed between the plates to support the atmospheric pressure.

There are a wide variety of shapes for such spacers, including elongated plate shapes. To manufacture such elongated plate shaped spacers, an apparatus has been used which grasps each of the end portions of the elongated plate shaped spacer in the longitudinal direction, so as to allow the elongated plate shaped spacer to be bonded to the rear plate with a high degree of positional precision (see Japanese Patent Laid-Open No. 2004-172097).

Increased demand for higher image quality of image display apparatuses has led to demand for higher positional precision of the spacers disposed therein, as well.

### SUMMARY OF THE INVENTION

The present invention provides a manufacturing method of an image display apparatus, enabling spacers to be arrayed on a substrate with high positional precision.

According to an aspect of the present invention, a method of manufacturing an image display apparatus having an elongated plate shaped spacer includes grasping an elongated plate shaped spacer with a pair of grasping members, applying tension to the grasped elongated plate shaped spacer toward both edges of the elongated plate shaped spacer in the longitudinal direction thereof, bringing the grasped elongated plate shaped spacer into contact with a substrate, and bonding the elongated plate shaped spacer to the substrate, wherein the grasping is performed such that a portion of the grasping members are brought into contact with the side of the elongated plate shaped spacer, wherein the region of contact between the grasping members and the side of the elongated plate shaped spacer is gradually spread toward the edge of the elongated plate shaped spacer in the longitudinal direction thereof.

Further features of the present invention will become apparent from the following description of exemplary embodiments with reference to the attached drawings.

### BRIEF DESCRIPTION OF THE DRAWINGS

FIG. 1 is a perspective view schematically illustrating the configuration of a display panel according to an example of an image display apparatus to which to the present invention is applied.

FIG. 2 is a perspective view schematically illustrating a step of bonding multiple spacers onto a substrate.

FIGS. 3A through 3C are perspective views schematically illustrating a step of grasping a spacer with hands according to the present invention.

FIGS. 4A and 4B are top views illustrating another form of a grasping member used with the present invention.

FIGS. 5A and 5B are top views illustrating another form of a grasping member used with the present invention.

FIGS. 6A and 6B are top views illustrating another form of a grasping member used with the present invention.

FIGS. 7A and 7B are top views schematically illustrating a step of grasping a spacer with hands.

FIG. 8 is a top view for describing distortion of a spacer.

### DESCRIPTION OF THE EMBODIMENTS

The present invention relates to manufacturing an image display apparatus having an elongated plate shaped spacer, thus enabling an elongated plate shaped spacer to be positioned on a substrate with high positional precision.

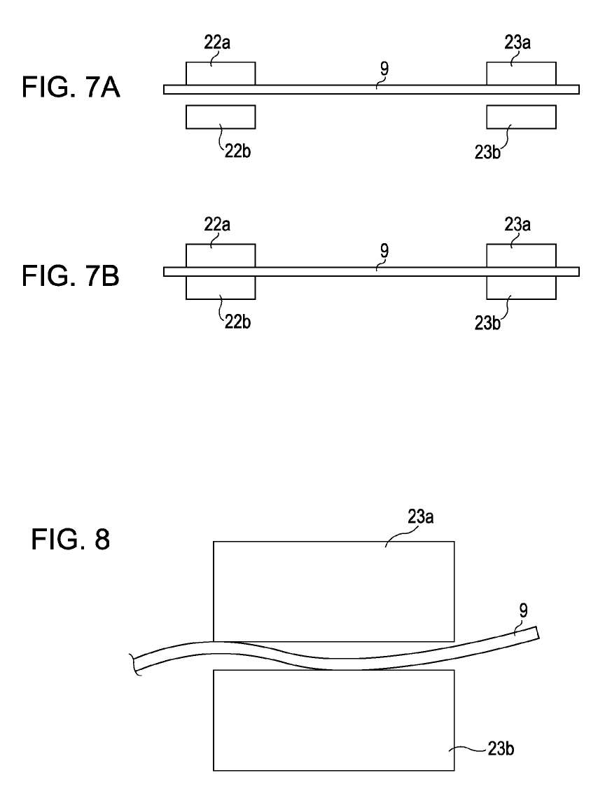

FIGS. 7A and 7B are top views schematically illustrating an example of a step of grasping a spacer. In FIGS. 7A and 7B, reference numeral 9 denotes an elongated plate shaped spacer, 22a and 23a denote reference claws, and 22b and 23b denote movable claws. The reference claw 22a and movable claw 22b, and reference claw 23a and movable claw 23b, each make up a grasping member, and the pair of grasping members grasp the elongated plate shaped spacer 9.

First, as shown in FIG. 7A, the reference claw 22a and movable claw 22b are brought into contact with the spacer 9, following which, as shown in FIG. 7B, the reference claw 23a and movable claw 23b are pressed against the spacer 9 so as to grasp the spacer 9.

Next, one or both of the grasping members are moved toward the edge of the spacer 9 in the longitudinal direction, thereby applying tension in the longitudinal direction of the spacer. In this state, one edge of the spacer 9 in the short direction is brought into contact with the substrate, so that the outer side of the grasped portions, i.e., the edge of the spacer 9 is bonded to the substrate. An adhesive agent or the like is used for this bonding.

FIG. 8 is a partially enlarged view of FIGS. 7A and 7B. The elongated plate shaped spacer 9 includes distortion such as warpage and undulation as can be seen in FIG. 8. This distortion is stretched out with the tension applied to the spacer 9 by the grasping members as described above on the inner side of the portions grasped with the grasping members, so in the event that the spacer 9 is bonded to the substrate at the inner side of the spacer 9, the positional precision is not affected. However, there may be cases wherein the distortion remains at the grasped portions and portions outside of the grasped portions, in which cases the distortion may lead to deviation in the bonded position of the spacer 9 following bonding. The Present Inventor has taken note of the above to make the present invention.

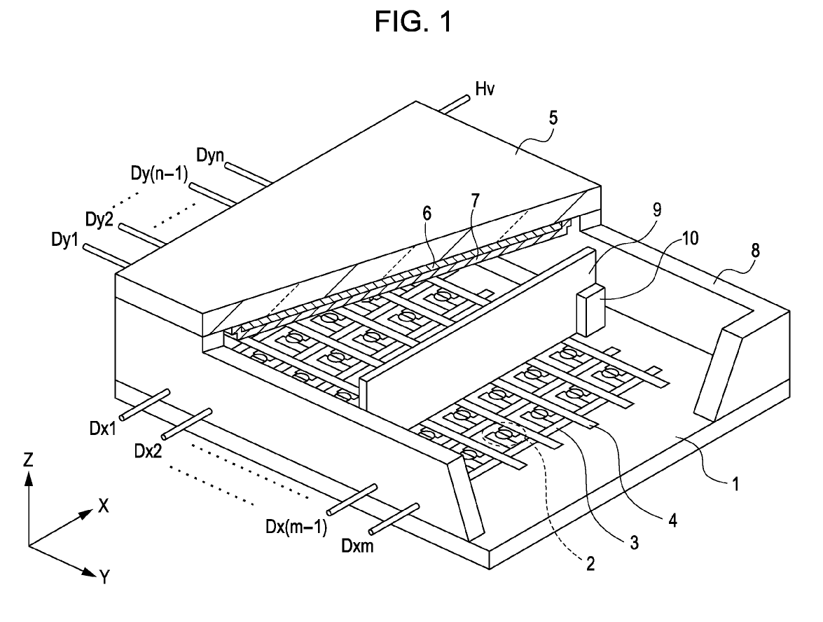

An embodiment of the manufacturing method according to the present invention will now be described in detail. FIG. 1 is a perspective view schematically illustrating a display panel according to an example of an image display device, which has been partially cut away.

In FIG. 1, reference numeral 1 denotes a rear plate which is the substrate, with multiple electron-emitting devices 2 and lines 3 and 4 arrayed thereupon. The multiple electron-emitting devices 2 are wired in matrix fashion on the rear plate 1 by the lines 3 and 4. Reference numeral 5 denotes a face plate which is the other substrate, with a fluorescent film 6 serving as a light emitting member and a metal back 7 disposed thereupon. The rear plate 1 and face plate 5 are bonded to each other with a frame 8 introduced therebetween such that the electron-emitting devices 2 and fluorescent film 6 face one another. The distance between the rear plate 1 and face plate 5 is maintained by an elongated plate shaped spacer 9. The elongated plate shaped spacer 9 is bonded onto the rear plate 1 using an adhesive agent 10.

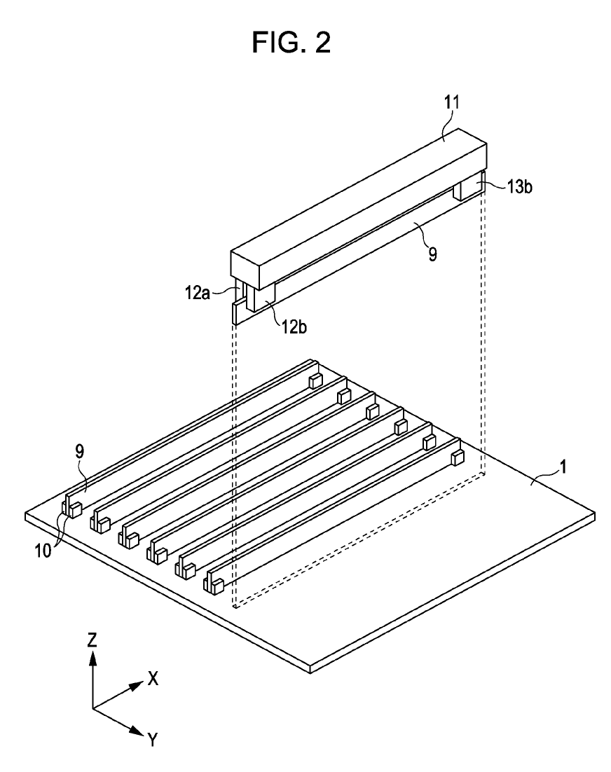

FIG. 2 is a perspective view schematically illustrating the way in which a step for bonding multiple elongated plate shaped spacers 9 to the rear plate is carried out, showing how a hand 11 holds the next elongated plate shaped spacer 9.

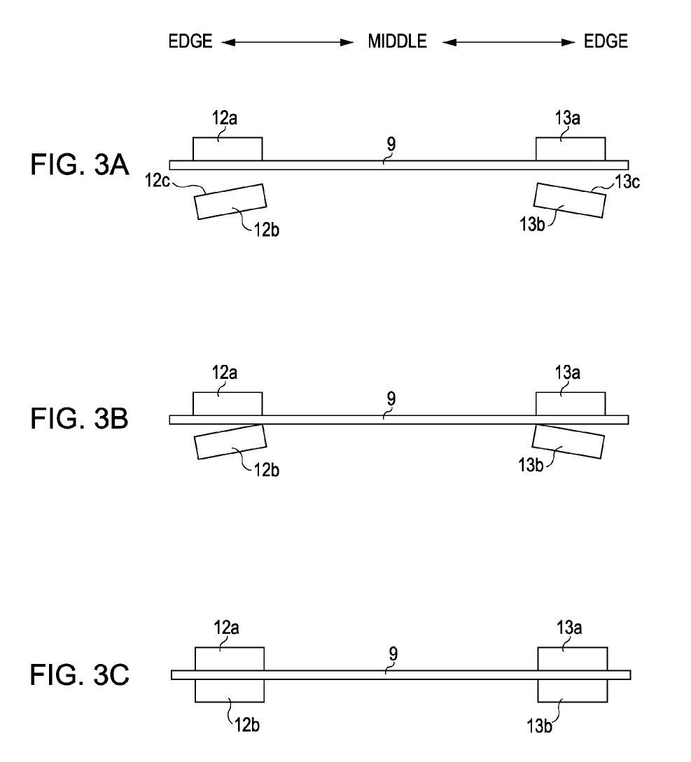

FIGS. 3A through 3C are top views schematically illustrating a step of grasping the elongated plate shaped spacer 9 with a hand. This step of grasping the elongated plate shaped spacer 9 with a pair of grasping members will be described next.

As shown in FIGS. 2 through 3C, the hand 11 has reference claws 12a and 13a which are fixed members, and movable claws 12b and 13b which are movable members, as grasping members. The elongated plate shaped spacer 9 is grasped by the reference claw 12a and movable claw 12b, and reference claw 13a and movable claw 13b. That is to say, the hand 11 has a pair of grasping members, each having a reference claw which is a fixed member and a movable claw which is a movable member, and the elongated plate shaped spacer 9 is grasped at two portions of the side thereof by the pair of grasping members. With the present embodiment, the hand 11 has a moving mechanism for the movable claws 12b and 13b so that the movable claws 12b and 13b can moved relative to the corresponding reference claws 12a and 13a.

The grasping members used with the present embodiment are arranged such that the distance between the movable claws 12b and 13b and the side of the elongated plate shaped spacer 9 is greater toward the edge of the elongated plate shaped spacer 9, and smaller toward the middle thereof. On the other hand, the faces of the reference claws 12a and 13a facing the elongated plate shaped spacer 9 are parallel to the side of the elongated plate shaped spacer 9.

With the present embodiment, as shown in FIG. 3A, first, the face of the reference claws 12a and 13a parallel to the side of the elongated plate shaped spacer 9 is brought into contact with the side of the elongated plate shaped spacer 9.

Next, faces 12c and 13c of the movable claws 12b and 13b which face the elongated plate shaped spacer 9 arranged so as to face the elongated plate shaped spacer 9 in a non-parallel manner, and the movable claws 12b and 13b are brought into contact with the side of the elongated plate shaped spacer 9 in this state. With the present embodiment, as shown in FIG. 3B, the distance between the faces 12c and 13c of the movable claws 12b and 13b and the side of the elongated plate shaped spacer 9 is greater toward the edge of the elongated plate shaped spacer 9 from the portion at which the movable claws 12b and 13b are in contact with the side of the elongated plate shaped spacer 9. Pressing the movable claws 12b and 13b against the side of the elongated plate shaped spacer 9 results in the face of contact of the faces 12c and 13c of the movable claws 12b and 13b as to the elongated plate shaped spacer 9 gradually spreads, toward the edges of the spacer 9 in the longitudinal direction.

At the side of the elongated plate shaped spacer 9, the faces 12c and 13c of the movable claws 12b and 13b gradually come into contact with the side of the elongated plate shaped spacer 9 in the direction from the middle of the spacer 9 outwards, and in this step, finally the entire area of the faces 12c and 13c are in contact with the elongated plate shaped spacer 9. Thus, with the present embodiment, grasping of the elongated plate shaped spacer with the grasping members is performed such that the grasping members are first brought into contact with the side of the spacer at one portion each, and then the areas of contact between the grasping members and the spacer are gradually spread out toward the edges of the spacer in the longitudinal direction. At the contact region between the side of the spacer and the grasping members, the side of the spacer is pulled outwards toward the edges of the spacer in the longitudinal direction, thereby correcting distortion in the side of the spacer, and this correction extends to the edges of the spacer.

Subsequently, one of both of the grasping members are moved toward the edge of the spacer in the longitudinal direction, thereby applying tension to the grasped spacer toward both edges of the spacer in the longitudinal direction.

With the present embodiment, a specific arrangement for bringing the faces 12c and 13c of the movable claws 12b and 13b sequentially into contact with the spacer 9 is not particularly restricted; however, the following arrangement can be suitably used.

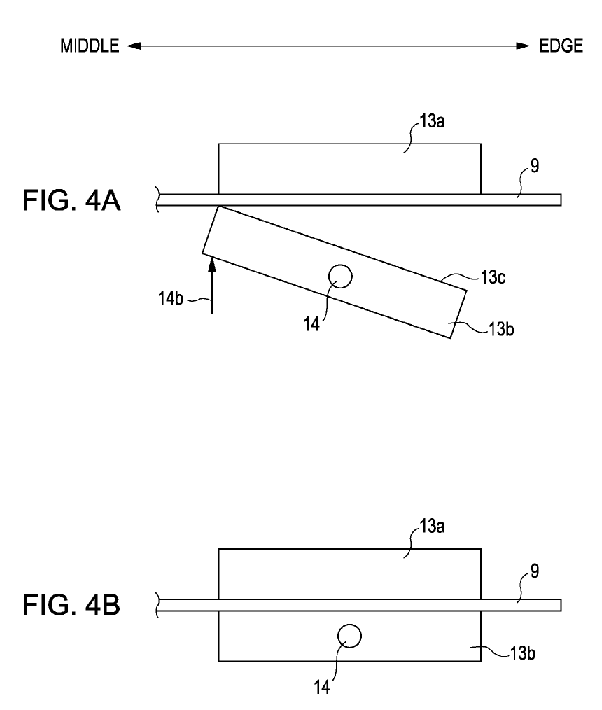

As shown in FIG. 4A, a rotational shaft 14 is provided so as to be parallel to the short direction of the spacer 9. Further, a pressing member 14b which presses the part of the movable claw 13b closer to the middle of the spacer 9 from the shaft 14 in the longitudinal direction of the spacer 9 is provided. The movable claw 13b is, in its entirety, brought close to the spacer 9, with the face 13c of the movable claw 13b which faces the side of the spacer 9 being non-parallel with the side of the spacer 9. Initially, the portion of the movable claw 13b closest to the middle of the spacer 9 comes into contact with the side of the spacer 9, and further advancing the entirety of the movable claw 13b toward the spacer 9 causes the face 13c of the movable claw 13b to gradually come into contact with a wider area of contact, in the direction from the middle of the spacer 9 toward the edges thereof, and finally the face 13c is completely in contact with the side of the spacer 9. An example of the member 14b which presses the claw 13b is a spring.

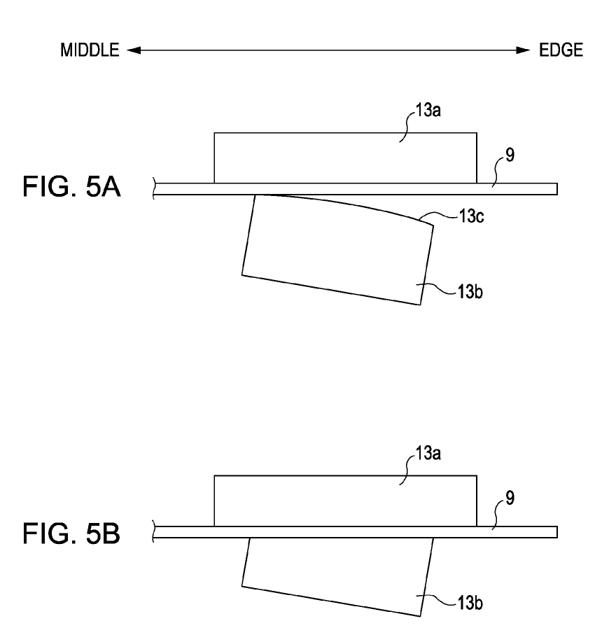

Another arrangement which can be applied is to form the movable claws with an elastic member, and to use the elastic deformation thereof. As shown in FIG. 5A, bringing the movable claw 13b formed of an elastic member into contact with the spacer 9 results in the area of contact gradually spreading from the middle of the spacer 9 toward the edges thereof in the longitudinal direction of the spacer 9 due to elastic deformation, until finally the entire face 13c is in contact with the side of the spacer 9, as shown in FIG. 5B. It is particularly desirable that the face 13c of the movable claw 13b is formed with a convex form in the longitudinal direction of the spacer 9 as shown in FIG. 5A, with that the contact area thereof is gradually spread.

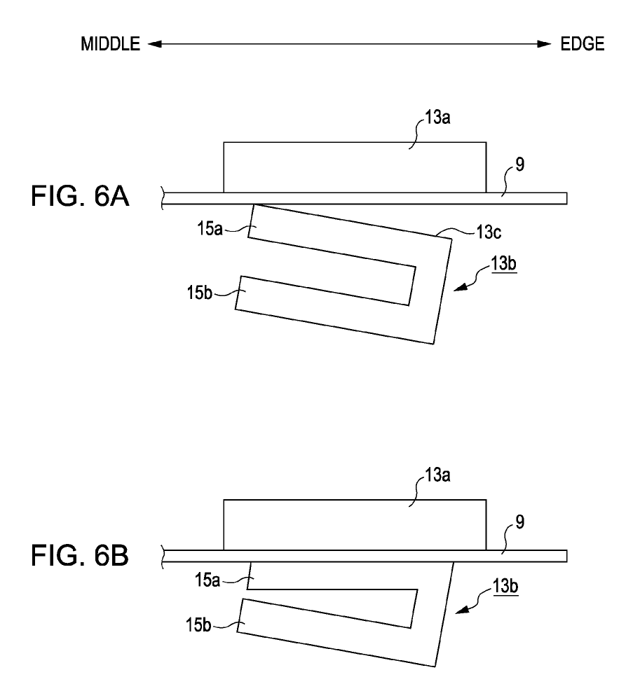

Further, another arrangement which can be applied is to form the movable claw 13b in a u-shape. Two legs 15a and 15b of the U-shaped movable claw 13b are arranged so as to face the middle of the spacer 9 in the longitudinal direction of the spacer 9. The face 13c of the leg 15a which faces the side of the spacer 9 is in a state not parallel with the side of the spacer 9. The movable claw 13b is supported at the free side, which is the leg 15b, and the movable claw 13b is in its entirety bright closer to the spacer 9, whereby the movable claw 13b comes into contact with the spacer from the direction of the middle of the spacer 9 in the longitudinal direction thereof and the area of contact gradually spreads due to elastic deformation, until finally the entire face 13c is in contact with the side of the spacer 9, as shown in FIG. 6B.

It should be noted that with the present embodiment, the face of the reference claws 12a and 12b facing the spacer are preferably smooth faces which have been subjected to precision grinding and polishing. Also, the faces of the reference claws 12a and 13a are preferably formed so as to be wider than the faces 12c and 13c of the movable claws 12b and 13c facing the spacer 9, in both the longitudinal direction and short direction of the spacer 9.

A spacer 9 which is grasped by the hand 11 in a state wherein distortion is corrected, and tension is applied toward both edges of the spacer in the longitudinal direction thereof, is transported above the rear plate 1 as shown in FIG. 2. The spacer 9 is perpendicularly lowered until the edge in the short direction of the spacer 9 comes into contact with the rear pate 1. Unshown alignment marks are provided on the rear plate 1, and the rear plate 1 and spacer 9 are positioned based on these marks. Unseeingly, the spacer 9 and the rear plate 1 are bonded using the adhesive agent 10 at a region outside of the region where the spacer 9 is held by the pair of grasping members.

An example of the adhesive agent 10 used with the present embodiment is a thermal hardening inorganic adhesive agent. The main component of this adhesive agent 10 is alumina, silica, magnesia, zirconia, or the like, suspended in a binder of water. Such an adhesive agent can be hardened by drying and evaporating the water by applying heat in the form of blowing with hot air, irradiation of a light beam, heating in an electric furnace, or the like.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-319088 filed Dec. 16, 2008, which is hereby incorporated by reference herein in its entirety.

What is claimed is:

1. A method of manufacturing an image display apparatus having an elongated plate shaped spacer, said method comprising:
grasping an elongated plate shaped spacer with a pair of grasping members;
applying tension to the grasped elongated plate shaped spacer toward both edges of the elongated plate shaped spacer in the longitudinal direction thereof;
bringing the grasped elongated plate shaped spacer into contact with a substrate; and
bonding the elongated plate shaped spacer to the substrate;
wherein said grasping is performed such that a portion of said pair of grasping members are brought into contact with a side of the elongated plate shaped spacer, wherein a region of contact between the grasping members and the side of the elongated plate shaped spacer is gradually spread toward both edges of the elongated plate shaped spacer in the longitudinal direction thereof.

2. The method according to claim 1, wherein said pair of grasping members each have an elastic member, with said elastic member coming into the side of said elongated plate shaped spacer.
